(19) United States
(12) Patent Application Publication
(10) Pub. No.: US 2025/0279089 A1
(43) Pub. Date: Sep. 4, 2025

(54) Using Synthetic Data to Improve Word Error Rate of Differentially Private ASR Models

(71) Applicant: Google LLC, Mountain View, CA (US)

(72) Inventors: Hongbin Liu, Mountain View, CA (US); Virat Vishnu Shejwalkar, Amherst, MA (US); Lun Wang, Fremont, CA (US); Om Dipakbhai Thakkar, Sunnyvale, CA (US); Abhradeep Guha Thakurta, Mountain View, CA (US); Arun Narayanan, Milpitas, CA (US)

(73) Assignee: Google LLC, Mountain View, CA (US)

(21) Appl. No.: 19/049,425

(22) Filed: Feb. 10, 2025

Related U.S. Application Data
(60) Provisional application No. 63/559,289, filed on Feb. 29, 2024.

(51) Int. Cl. G10L 15/06; G10L 13/08; G10L 25/30

(52) U.S. Cl. CPC G10L 15/063; G10L 13/08; G10L 25/30

(57) ABSTRACT

A method includes pre-training an audio encoder on a public training utterance set and from a corpus of text utterances, sampling a predetermined number of most frequent words that appear in the corpus of text utterances. The method also includes randomly generating a predetermined number of transcripts, and for each corresponding transcripts, processing, using a TTS system, the corresponding transcript to generate a corresponding synthetic speech utterance. The corresponding transcript and the corresponding synthetic speech utterance form a corresponding synthetic training sample. During a first fine-tuning stage, the method also includes fine-tuning an ASR model on the synthetic training samples. During a second fine-tuning stage, the method also includes fine-tuning, using a differentially private parameter-efficient-fine-tuning (DP-PEFT) technique, the ASR model on the plurality of private training samples, wherein the DP-PEFT technique updates only a subset of newly added or existing parameters of the pre-trained audio encoder.

### CROSS REFERENCE TO RELATED APPLICATIONS

This U.S. patent application claims priority under 35 U.S.C. § 119 (e) to U.S. Provisional Application 63/559,289, filed on Feb. 29, 2024. The disclosure of this prior application is considered part of the disclosure of this application and is hereby incorporated by reference in its entirety.

### TECHNICAL FIELD

This disclosure relates to using synthetic data to improve word error rate of differentially private ASR models.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Modern ASR models continue to improve in both accuracy (e.g. a low word error rate (WER)) and latency (e.g., delay between the user speaking and the transcription) based on the ongoing development of deep neural networks. However, one challenge in developing deep learning-based ASR models is that parameters of the ASR models tend to over fit the training data, thereby resulting in the ASR models having difficulties generalizing unseen data when the training data is not extensive enough.

### SUMMARY

One aspect of the disclosure provides a computer-implemented method that when executed on data processing hardware causes the data processing hardware to perform operations for fine-tuning large automated speech recognition (ASR) models with a strict differentially-private guarantee. The operations include obtaining a pubic training utterance set and pre-training an audio encoder on the public training utterance set. The operations also include obtaining a plurality of private training samples that each include a corresponding non-synthetic speech utterance paired with a corresponding transcription, and from a corpus of text utterances, sampling a predetermined number of most frequent words that appear in the corpus of text utterances. The operations also include randomly generating a predetermined number of transcripts that each include a same number of words randomly sampled from the predetermined number of most frequent words. For each corresponding transcript of the predetermined number of transcripts, the operations also include processing, using a text-to-speech (TTS) system, the corresponding transcript into a corresponding synthetic speech utterance. Here, the corresponding transcript and the corresponding synthetic speech utterance form a corresponding synthetic training sample. During a first fine-tuning stage for fine-tuning an automatic speech recognition (ASR) model that includes the pre-trained audio encoder and a decoder, the operations also include fine-tuning the ASR model on each of the synthetic training samples to teach the ASR model to learn how to predict the transcripts from the corresponding synthetic speech utterances. During a second fine-tuning stage for fine-tuning the ASR model, the operations also include fine-tuning, using a differentially private parameter-efficient fine-tuning (DP-PEFT) technique, the Asr model on the plurality of private training samples. Here, the DP-PEFT technique updates only a subset of newly added or existing parameters of the pre-trained audio encoder.

Implementations of the disclosure may include one or more of the following optional features. In some implementations, the public training utterance set includes publicly-available utterances including a plurality of un-transcribed non-synthetic speech utterances, wherein each un-transcribed non-synthetic speech utterance is not paired with a corresponding transcription. In these implementations, pre-training the audio encoder on the public training utterance set includes, for each corresponding un-transcribed non-synthetic speech utterance in the public training utterance set: generating, at each of a plurality of output steps, using a random-projection quantizer, a target quantized vector token and a target token index for a corresponding audio feature in a sequence of audio features associated with the corresponding un-transcribed non-synthetic speech utterance, wherein the target token index maps the corresponding audio feature to the target quantized vector token stored in one or more codebooks; after masking a subset of the audio features in the sequence of audio features associated with the corresponding un-transcribed non-synthetic speech utterance, generating, by the audio encoder, contrastive context vectors from corresponding masked audio features; and deriving a contrastive loss term between the contrastive context vectors at the masked positions and the target token index. Thereafter, pre-training the audio encoder includes pre-training the uaido encoder based on the contrastive loss terms derived for each of the un-transcribed non-synthetic speech utterances in the public training utterance set.

In some examples, the audio encoder includes a stack of multi-head attention layers each including am multi-headed self-attention mechanism. For instance, the stack of multi-head attention layers may include a stack of conformer layers. The stack of conformer layers may include a stack of 245 layers having about 600 million parameters. In these examples, the DP-PEFT technique may include modifying the audio encoder to incorporate adapters that each incorporate two low-rank projection matrices and one activation layer, wherein only the parameters of the adapters are updated during the fine-tuning. Alternatively, the DP-PEFT technique may include modifying the audio encoder to incorporate two low-rank projection matrices parallel to feed-forward layers of the audio encoder, wherein only parameters of the two low-rank projection matrices are updated during the fine-tuning Optionally, the DP-PEFT technique may include Bias-Term Fine-Tuning (BitFit) where only bias parameters of the stack of multi-head attention layers are updated during the fine-tuning. In some implementations, fine-tuning, using the DP-PEFT technique, the Asr model on the plurality of private training samples fine-tunes the Asr model according to a differential privacy budget that defines a maximum acceptable amount of information about individual training samples of the plurality of private training samples that may be revealed or leaked by the ASR model.

Another aspect of the disclosure provides a system that includes data processing hardware and memory hardware storing instructions that when executed on the data processing hardware causes the data processing hardware to perform operations. The operations include obtaining a pubic training utterance set and pre-training an audio encoder on the public training utterance set. The operations also include obtaining a plurality of private training samples that each include a corresponding non-synthetic speech utterance paired with a corresponding transcription, and from a corpus of text utterances, sampling a predetermined number of most frequent words that appear in the corpus of text utterances. The operations also include randomly generating a predetermined number of transcripts that each include a same number of words randomly sampled from the predetermined number of most frequent words. For each corresponding transcript of the predetermined number of transcripts, the operations also include processing, using a text-to-speech (TTS) system, the corresponding transcript into a corresponding synthetic speech utterance. Here, the corresponding transcript and the corresponding synthetic speech utterance form a corresponding synthetic training sample. During a first fine-tuning stage for fine-tuning an automatic speech recognition (ASR) model that includes the pre-trained audio encoder and a decoder, the operations also include fine-tuning the ASR model on each of the synthetic training samples to teach the ASR model to learn how to predict the transcripts from the corresponding synthetic speech utterances. During a second fine-tuning stage for fine-tuning the ASR model, the operations also include fine-tuning, using a differentially private parameter-efficient fine-tuning (DP-PEFT) technique, the Asr model on the plurality of private training samples. Here, the DP-PEFT technique updates only a subset of newly added or existing parameters of the pre-trained audio encoder.

Implementations of the disclosure may include one or more of the following optional features. In some implementations, the public training utterance set includes publicly-available utterances including a plurality of un-transcribed non-synthetic speech utterances, wherein each un-transcribed non-synthetic speech utterance is not paired with a corresponding transcription. In these implementations, pre-training the audio encoder on the public training utterance set includes, for each corresponding un-transcribed non-synthetic speech utterance in the public training utterance set: generating, at each of a plurality of output steps, using a random-projection quantizer, a target quantized vector token and a target token index for a corresponding audio feature in a sequence of audio features associated with the corresponding un-transcribed non-synthetic speech utterance, wherein the target token index maps the corresponding audio feature to the target quantized vector token stored in one or more codebooks; after masking a subset of the audio features in the sequence of audio features associated with the corresponding un-transcribed non-synthetic speech utterance, generating, by the audio encoder, contrastive context vectors from corresponding masked audio features; and deriving a contrastive loss term between the contrastive context vectors at the masked positions and the target token index. Thereafter, pre-training the audio encoder includes pre-training the uaido encoder based on the contrastive loss terms derived for each of the un-transcribed non-synthetic speech utterances in the public training utterance set.

In some examples, the audio encoder includes a stack of multi-head attention layers each including am multi-headed self-attention mechanism. For instance, the stack of multi-head attention layers may include a stack of conformer layers. The stack of conformer layers may include a stack of 245 layers having about 600 million parameters. In these examples, the DP-PEFT technique may include modifying the audio encoder to incorporate adapters that each incorporate two low-rank projection matrices and one activation layer, wherein only the parameters of the adapters are updated during the fine-tuning. Alternatively, the DP-PEFT technique may include modifying the audio encoder to incorporate two low-rank projection matrices parallel to feed-forward layers of the audio encoder, wherein only parameters of the two low-rank projection matrices are updated during the fine-tuning Optionally, the DP-PEFT technique may include Bias-Term Fine-Tuning (BitFit) where only bias parameters of the stack of multi-head attention layers are updated during the fine-tuning. In some implementations, fine-tuning, using the DP-PEFT technique, the Asr model on the plurality of private training samples fine-tunes the Asr model according to a differential privacy budget that defines a maximum acceptable amount of information about individual training samples of the plurality of private training samples that may be revealed or leaked by the ASR model

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system

FIG. 2 is a schematic view of a Recurrent Neural Network-Transducer (RNN-T) model architecture.

FIG. 3 is a schematic view of an example pre-training process for pre-training an audio encoder.

FIG. 4A is a schematic view of an example first fine-tuning stage for fine-tuning an automated speech recognition (ASR) model that includes the pre-trained audio encoder.

FIG. 4B is a schematic view of an example second fine-tuning stage for fine-tuning the ASR model using a differentially private-parameter-efficient-fine-tuning (DP-PEFT) technique.

FIG. 5 is a schematic view of an example synthetic training sample generation process.

FIG. 6 is a flowchart of an example arrangement of operations for applying differentially private parameter-efficient fine-tuning (DP-PEFT) techniques for fine-tuning a large ASR model on downstream speech recognition tasks with a strict DP guarantee.

FIG. 7 is a schematic view of an example computing device that may be used to implement the systems and methods described herein.

Like reference symbols in the various drawings indicate like elements.

### DETAILED DESCRIPTION

Automated speech recognition has made tremendous strides with the introduction of sequence to sequence (Seq2Seq) models that map from audio to character sequences. At the same time, text-to-speech (TTS) or speech syntheses systems have successfully applied Seq2Seq models to obtain state of the art natural, realistic sounding synthesized speech that can be indistinguishable to the human ear from human speech.

One challenge in developing deep learning-based ASR models is that parameters of the ASR models tend to over fit the training data, thereby resulting in the ASR models having difficulties generalizing unseen data when the training data is not extensive enough. Thus, training ASR models on larger training datasets improves the accuracy of the ASR model. For instance, the use of machine learning or other statistical methods can train ASR models on training data sets that include upwards of 10,000 hours of transcribed speech. Yet, performance of ASR models suffers when a domain associated with the training data is distinct from a domain at which the ASR model will be deployed during inference. For example, training an ASR model on transcribed speech in a domain associated with video meetings would be less effective in recognizing speech related to voice search queries, and vice versa.

Un-transcribed speech utterances have the potential to drastically limit the amount of labeled human speech required to train large ASR models, while also providing flexibility in moving the ASR model across different domain domains. Furthermore, un-transcribed speech utterances can be easily collected across a vast number of different languages since labeled (e.g., transcribed) speech utterances can be difficult to obtain for lower resource languages. As a result, self-supervised and/or semi-supervised training techniques can be applied to pre-train an audio encoder of a large ASR model on a large corpus of un-transcribed speech utterances to teach the audio encoder to learn general representations conveyed by the un-transcribed speech utterances. For instance, the audio encoder may be pre-trained on a set of un-transcribed speech utterances using Bidirectional Encoder Representations from Transformers (BERT)-based speech pre-training with random projection quantizer (BEST-RQ). Thereafter, the large ASR model may integrate the pre-trained audio encoder together with a speech decoder and a fine-tuning stage may adapt the large ASR model for downstream speech recognition tasks by fine-tuning the large ASR model on domain-specific datasets.

Privacy is an important consideration as these large ASR models are capable of memorizing outliers in fine-tuning datasets. Differential privacy refers to a system for sharing information from a dataset without revealing information about individuals from the dataset. That is, a user who receives differentially private information from a dataset ideally cannot infer any information about a single individual of the dataset. This allows, for example, the publication of demographic information while ensuring the privacy of individuals who provide the information. Differentially private (DP) machine learning is commonly used for training private models on private data. A trained DP model is trained to not reveal sensitive information from the private data used to train the DP model. That is, an observer of a DP model cannot infer from the predictions of the DP model whether data of a particular entity was used to train the model. Differentially private stochastic gradient descent (DP-SGD) has become a de facto standard algorithm for centralized training of DP models. However, naïve application of DP-SGD on large ASR models has shown to hinder model performance and incur higher computational costs which can be prohibitive for large ASR models whose training cost is already high.

Implementations herein are directed toward applying differentially private parameter-efficient fine-tuning (DP-PEFT) techniques for fine-tuning a large ASR model on downstream speech recognition tasks with a strict DP guarantee. Initially, an audio encoder of the large ASR model may be pretrained on a large amount of publicly available utterances using unsupervised and/or self-supervised training techniques such as BEST-RQ. After pre-training the audio encoder, techniques disclosed herein sample a predetermined number of most frequent words that appear in a public corpus of text utterances, randomly generate a predetermined number of transcripts that each include a same number of words randomly sampled from the predetermined number of most frequent words, generate corresponding synthetic speech utterances by converting the predetermined number of transcripts via a text-to-speech (TTS) system, and during a first fine-tuning stage, fine-tuning the ASR model including the pretrained audio encoder on each of the synthetic training samples to teach the ASR model to learn how to predict the transcripts from the corresponding synthetic speech utterances. Thereafter, during a second fine-tuning stage, a DP-PEFT technique further fine-tunes the ASR model on a plurality of private training samples that each include a corresponding non-synthetic speech utterance paired with a corresponding transcription. Here, the DP-PEFT technique updates only a subset of newly added or existing parameters of the pre-trained audio encoder while achieving a strict DP guarantee.

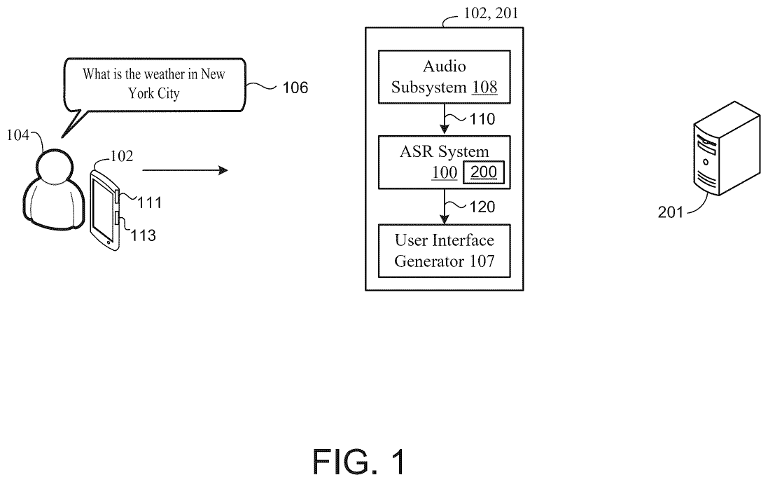

FIG. 1 illustrates an automated speech recognition (ASR) system 100 implementing an ASR model 200 that resides on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a large language model or natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

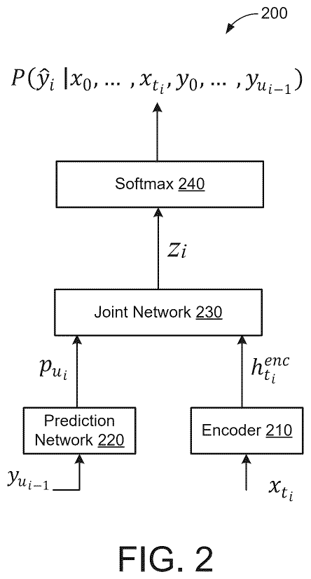

Referring to FIG. 2, an example frame alignment-based transducer model 200 includes a Recurrent Neural Network-Transducer (RNN-T) model architecture which adheres to latency constrains associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a joint network 230. The encoder network 210 (also referred to as ‘audio encoder’ 210), which is roughly analogous to an acoustic model (AM) in a traditional ASR system, includes a stack of multi-head attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1)) x=(x₁, x₂, . . . , x_{T}), where xᵢ∈ [symbol] _{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of multi-head attention layers/blocks, such as conformer blocks. Here, each conformer block includes a series of multi-headed self attention, depth wise convolution and feed-forward layers. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

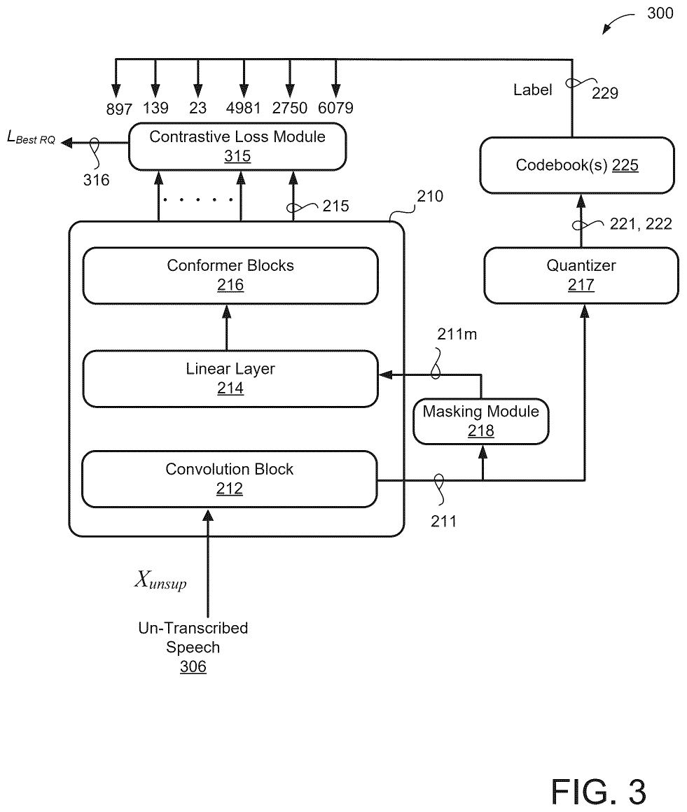

FIG. 3 illustrates an example pre-training process 300 for pre-training the audio encoder 210 of the ASR model 200 (FIGS. 1 and 2). The pre-training process may pre-train the audio encoder 210 on a public training utterance set that includes publicly-available utterances that include a plurality of un-transcribed non-synthetic speech utterances (Xᵤₙₛᵤₚ) 306. Here, each un-transcribed non-synthetic speech utterance 306 (also referred to as simply “un-transcribed speech utterance 306”) includes audio-only data (i.e., unpaired data) such that the un-transcribed speech utterance 306 is not paired with any corresponding transcription. In some examples, the un-transcribed speech utterances 306 are multi-lingual utterances from a plurality of different languages, for example, hundreds of different languages. However, the plurality of un-transcribed speech utterances 306 may only include utterances spoken in a single language without departing from the scope of the present disclosure.

The pre-training process 300 pre-trains the audio encoder 210 on a contrastive losses (L_{w2v}) 316 derived from the un-transcribed non-synthetic speech utterances (Xᵤₙₛᵤₚ) 306. The audio encoder 210 includes incudes a plurality of multi-head attention blocks (interchangeably referred to as ‘multi-head attention layers’). For instance, the audio encoder 210 may include Conformer encoder including a stack of conformer blocks each of which includes a series of multi-headed self attention, depth wise convolution, and feed-forward layers. Alternatively, the audio encoder 210 may include another type of encoder having a stack of multi-head attention layers/blocks, such as a transformer encoder. For simplicity, the audio encoder 210 will be referred to as a Conformer encoder 210. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each un-transcribed non-synthetic speech utterance 306, and generates, as output, for each of a plurality of output steps, an encoded audio feature 211 that corresponds to a respective one of the un-transcribed non-synthetic speech utterances 306.

The encoded audio features 211 (i.e., interchangeably referred to as “encoded features 211”) output from the convolution subsampling block 212 may be fed to a masking module 218 where some of the encoded features 211 are randomly chosen and replaced with a trained feature vector shared between all masked time steps to provide corresponding masked encoded audio features 211, 211m. In some examples, the masking module 218 masks the randomly chosen encoded features 211 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211 not chosen by the masking module 218) and outputs corresponding contrastive context vectors (i.e., encoded representation) 215 from masked encoded features 211m.

Moreover, a quantizer 217 receives the encoded features 211 as input, and applies random projections to generate, at each of the plurality of output steps, a target quantized vector token 221 and a target token index 222 for a corresponding encoded feature 211 as output. As such, the quantizer 217 generates the target quantized vector token 221 and the target token index 222 using the encoded representations 211 that do not include any masking. Here, the quantizer 217 generates the target quantized vector tokens 221 according to

$${q}_{i} ∈ {\{ {e}_{j} \}}_{j = 1}^{V} .$$

The quantizer 217 summarizes all of the encoded features 211, 213 into representative target quantized vector tokens (i.e., discriminative speech tokens) 221. The representative target quantized vector tokens 221 generated by the quantizer 217 represent a finite set of representative target quantized vector tokens referred to as a codebook 225. The target token index 222 maps each corresponding encoded feature 211 to a respective one of the target quantized vector tokens 221 stored in the codebook 225. In some implementations, the quantizer 217 projects the target context vector 221 to a randomly initialized codebook 225 that maps the target context vectors 221 to discrete labels 229 by finding a nearest vector in the codebook 225. Here, the target context vector 221 collectively refers to the target quantized vector tokens 221 and the target token index 222. Notably, the quantizer 217 includes a random-projection quantizer 217 configured to randomly initialize a matrix and the codebook 225. The random-projection quantizer 217 uses the matrix to project the encoded features 211 into the target context vectors 221 and uses the codebook 225 to find a nearest vector where an index of the vector includes the label 229. In some examples, the codebook 225 finds the nearest vector by determining a cosine similarity as a distance measurement.

Thereafter, a contrastive loss module 315 derives a contrastive loss term (L_{Best RQ}) 316 between the contrastive context vectors 215 at the masked positions and the target context vectors 221 as follows.

$$L = - log \frac{exp ( sim ( {c}_{t} , {q}_{t} ) / k )}{{\sum }_{\tilde{q} ∼ {Q}_{t}} exp ( sim ( {c}_{t} , {\tilde{q}}_{t} ) / k )} \qquad ( 5 )$$

where cᵢ is contrastive context vector 215 centered over a masked time step t and qₜ represents a target context vector 221 at the time step t in a set of K+1 candidate target context vectors 221 which includes qₜ and K distractors. Distractors may be uniformly sampled from other masked time steps of the same utterance. Advantageously, the contrastive loss 316 represents a Bidirectional Encoder Representations from Transformers (BERT)-based Speech pre-Training with Random Projection Quantizer (BEST-RQ) loss does not require an additional quantization module that other contrastive losses (e.g., w2v-BERT) require. As such, since the BEST-RQ loss does not require the additional quantization module, the BEST-RQ loss enables the ASR model 200 to be more scalable for multiple languages during pre-training.

The contrastive loss 316 is optimized between the contrastive context vectors 215 at the masked positions and the target context vectors 221. Thus, the contrastive loss 316 may be optimized for real/human (non-synthetic) utterances that are publicly-available, and thus, there are no privacy concerns with using the un-transcribed speech utterances 306 for pre-training the audio encoder 210. Accordingly, the pre-training process 300 pre-trains the audio encoder 210 on the derived contrastive loss 316 applied on the corresponding encoded features 211 associated with each un-transcribed non-synthetic speech utterance 306 provided as input to the audio encoder 210. Pre-training the audio encoder 210 may include updating parameters of the audio encoder 210 based on the contrastive losses 316.

In some implementations, the pre-training process 300 uses one or more codebooks 225 instead of using a single codebook 225. For example, the pre-training process 300 may use sixteen (16) codebooks 225. More specifically, the audio encoder 210 generates N number of contrastive context vectors 215 (e.g., probability predictions output from the audio encoder 210) using a corresponding N number of softmax output layers for each encoded feature 211. This is in contrast to generating a single contrastive context vector 215 for each encoded feature 211 using a single codebook 225. To that end, the pre-training process 300 randomly initializes N number of different codebooks 225 and, using each respective codebook 225 of the N number of codebooks 225, to finds a respective nearest vector where an index of the vector includes the corresponding label 229 of the respective codebook 225. By using multiple codebooks 225, the pre-training process 300 compares N number of contrastive context vectors 215 to a corresponding N number of labels 229 for each encoded feature 211. Advantageously, using multiple codebooks 225 enables the pre-training process 300 to improve stability and convergence of the audio encoder 210 during pre-training. In some examples, the pre-training process 300 pre-trains the audio encoder 210 using equal weights for each softmax layer output of the audio encoder 210.

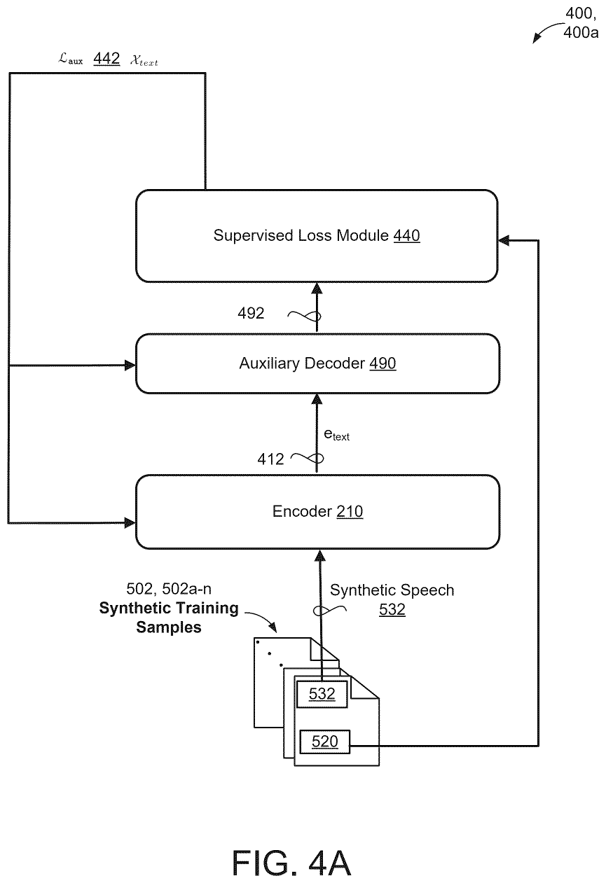

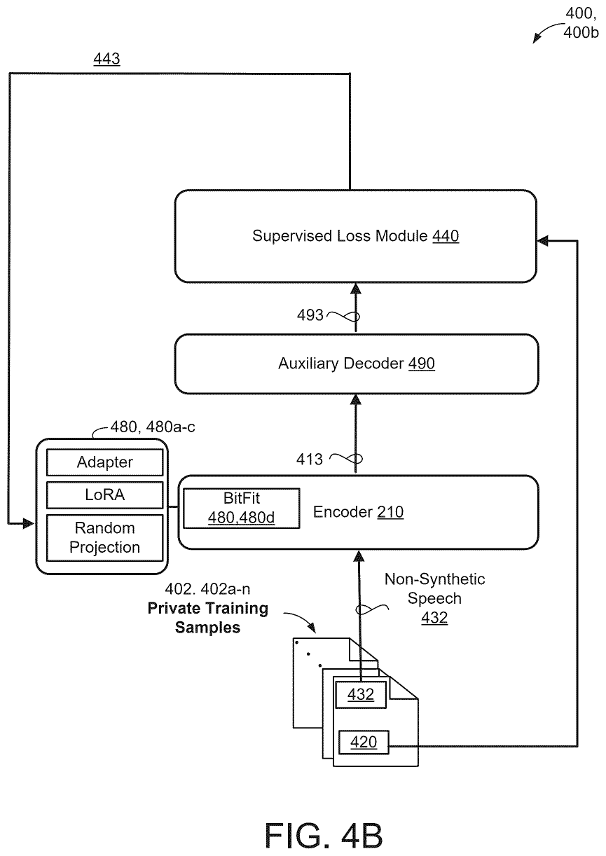

Referring to FIGS. 4A and 4B, after pre-training the audio encoder 210 using the pre-training process 300 of FIG. 3, a fine-tuning process 400 fine-tunes an ASR model 200 including the pre-trained audio encoder 210 and an auxiliary decoder 490. Specifically, the fine-tuning process 400 includes a first fine-tuning stage 400a (FIG. 4A) and a second fine-tuning stage 400b (FIG. 4B) The first fine-tuning stage 400a fine-tunes the ASR model based on synthetic training samples 502. After the first-fine tuning stage 400a fine-tunes the ASR model based on the synthetic training samples 502, the second fine-tuning stage 400b uses a differentially private parameter-efficient-fine-tuning (DP-PEFT) technique to fine-tune the ASR model 200 based on a plurality of private training samples 402, 402a-n. Each private training sample 402 includes an utterance of non-synthetic speech 432 paired with a corresponding ground-truth transcription 420 of the utterance. The information of the private training samples 402 is to be kept private and preserved such that the information does not leak or cannot be extracted from the ASR model 200 after the ASR model 200 is trained on the private training samples 402. Accordingly, the DP-PEFT technique fine-tunes the ASR model on the private training samples 402 according to a differential privacy budget that defines a maximum acceptable amount of information about individual training samples of the plurality of private training samples 402 that may be revealed or leaked by the ASR model 200. In some examples, the DP-PEFT sets a clipping bound C equal to 2.5 and sets a noise multipler to achieve a privacy budget equal to 10.0 for strong privacy protection.

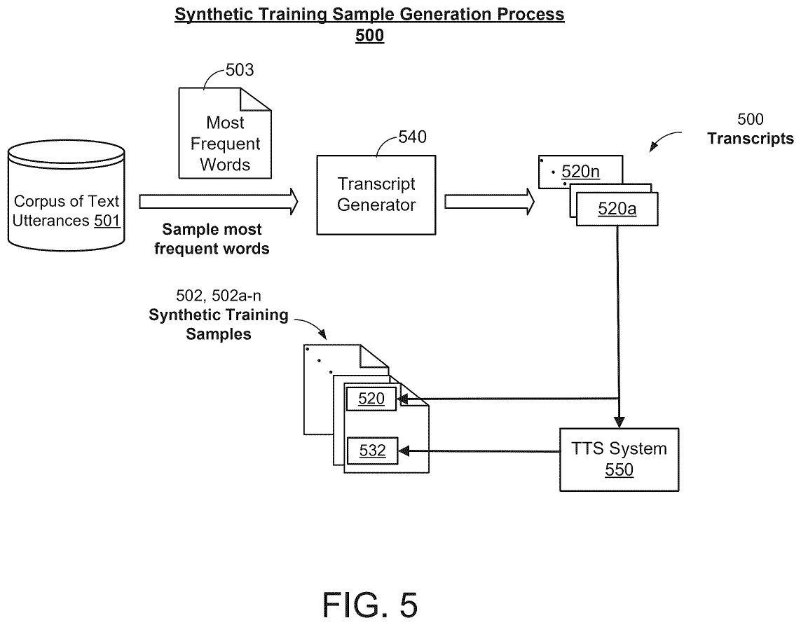

Referring to FIG. 5, a synthetic training sample generation process 400 may generate the synthetic training samples 502 used for fine-tuning the ASR model 200 during the first fine-tuning stage 400a (FIG. 4A) of the fine-tuning process 400. Initially, the synthetic training sample generation process 400 samples a predetermined number of most frequent words 503 that appear in a corpus of text utterances 501. The corpus of text utterances 501 may include text-only utterances that are not paired with any corresponding audio/speech representation of the utterances. In some examples, the process 400 samples the 10,000 most frequent words 503 that appear in the corpus of text utterances 501. Thereafter, the synthetic training sample generation process 500 employs a transcript generator that receives the predetermined number of most frequent words 503 that appear in the corpus of text utterances 501 and randomly generates a predetermined number of transcripts 520, 520a-n. Here, each transcript includes a same number of words randomly sampled from the predetermined number of most frequent words 503. For instance, each transcript 520 generated by the transcript generator may include seven words randomly sampled from the most frequent words 503. The transcript generator 540 may randomly sample less than seven words or more than seven words from the most frequent words 503 when generating each transcript 520 without departing from the scope of the present disclosure. Ideally, the same number of words included in each transcript 520 and randomly sampled from the most frequent words 503 may be chosen such that the transcripts 520 include a sufficient word length that captures short natural phrases while still allowing substantially linguistic variety across the predetermined number of most frequent words 503.

Finally, the synthetic training sample generation process 500 provides, as input, each corresponding transcript 520 having the same number of words randomly sampled from the most frequent words 503 to a text-to-speech (TTS) system that converts the corresponding transcript 520a into a corresponding synthesized speech utterance 532. For instance, for a first transcript 520a the TTS system 550 generates a corresponding first synthesized speech utterance 532 that characterizes the number of words included in the first transcript 520a in a synthetic voice. Each corresponding transcript 520 and the corresponding synthetic speech utterance 504 form a corresponding synthetic training sample 502. Accordingly, the synthetic training sample generation process 500 generates a plurality of synthetic training samples 502, 502a-n that each include a corresponding one of the predetermined number of transcripts 520 generated by the transcript generator 540 and the corresponding synthetic speech utterance 532 output from the TTS system 550. In some scenarios, the TTS system 550 may receive other inputs such speaker embeddings to produce synthesized speech utterances 504 in different voices, as well as style, prosody, and/or accent embeddings to produce synthesized speech utterances 504 with different styles, prosodies, and/or accents.

Referring to FIG. 4A, the first fine-tuning stage 400a of the fine-tuning process 400 is configured to inject lexical information into the audio encoder 210 based on supervised loss terms 442 derived from the synthesized speech utterances 532 generated by the TTS system 550 for the predetermined number of transcripts 520 generated by the synthetic training sample generation process 500. Notably, the first fine-tuning stage 400a leverages an auxiliary decoder 490 for generating the supervised loss terms 442. The auxiliary decoder 490 may include a Connectionist Temporal Classification (CTC) decoder, a Listen Attend Spell (LAS) decoder, or a RNN-T decoder. The auxiliary decoder 490 may include at least one of a phoneme decoder configured to decode a sequence of phonemes or a wordpiece decoder configured to decode a sequence of word pieces. The auxiliary decoder 490 could also include a grapheme decoder configured to decode a sequence of graphemes. In some examples, the first fine-tuning stage 400a applies data augmentation to at least one of the sample utterances of synthetic speech utterances 552 to provide one or more lexically-diverse synthetic speech utterances 552 for a given transcript 520. The data augmentation may include, without limitation, adding noise, manipulating timing (e.g., stretching), or adding reverberation to the corresponding speech representation. Data augmentation may add different synthesized recording conditions to the synthesized speech utterances 552.

During the first fine-tuning stage 400a, the audio encoder 210 receives, as input, each synthetic speech utterance 532 generated from the corresponding transcript 520 of each synthetic training sample 502 as a sequence of features/vectors (e.g., mel-frequency spectrograms such as the acoustic frames 110 of FIG. 1) and generates, as output, for each of a plurality of time steps, a first encoded representation (eₜₑₓₜ) 412 that corresponds to the synthetic speech utterance 532 at the corresponding time step. The auxiliary decoder 490 including the phoneme decoder or the wordpiece decoder receives, as input, each first encoded representation 412 output from the audio encoder 210 and generates, as output, a first probability distribution 492 over possible synthetic speech recognition hypotheses for the corresponding synthesized speech utterance 532 at the corresponding time step. In some examples, the first probability distribution 492 over possible synthetic speech recognition hypotheses includes one of possible phoneme labels or possible word piece labels. Thereafter, a supervised loss module 440 may determine a synthetic speech loss term 442 based on the first probability distribution 492 over possible synthetic speech recognition hypotheses and the corresponding transcript 520. Here, the corresponding transcript 620 in which the synthesized speech utterance 532 is generated from also serves as a ground-truth transcription. The first fine-tuning stage may fine-tune the ASR model 200 on the synthetic speech loss term 342 by updating parameters of the audio encoder 210 and/or the decoder 490.

Referring to FIG. 4B, the second fine-tuning stage 400b of the fine-tuning process 400 is configured to fine-tune the ASR model on supervised loss terms 443 derived from the utterances of non-synthetic speech 432 and the corresponding ground-truth transcriptions 420 of the plurality of private training samples 402. As with the first fine-tuning stage 400a, the second fine-tuning stage 400b also leverages the same or different auxiliary decoder 490 for generating the supervised loss terms 443. The auxiliary decoder 490 may include a Connectionist Temporal Classification (CTC) decoder, a Listen Attend Spell (LAS) decoder, or a RNN-T decoder. The auxiliary decoder 490 may include at least one of the phoneme decoder, wordpiece decoder, or grapheme decoder.

During the second fine-tuning stage 400b, the audio encoder 210 receives, as input, each non-synthetic speech utterance 432 of each private training sample 402 as a sequence of features/vectors (e.g., mel-frequency spectrograms such as the acoustic frames 110 of FIG. 1) and generates, as output, for each of a plurality of time steps, a second encoded representation (eₜₑₓₜ) 413 that corresponds to the non-synthetic speech utterance 432 at the corresponding time step. The auxiliary decoder 490 including the phoneme decoder or the wordpiece decoder receives, as input, each second encoded representation 413 output from the audio encoder 210 and generates, as output, a second probability distribution 493 over possible synthetic speech recognition hypotheses for the corresponding synthesized speech utterance 532 at the corresponding time step. In some examples, the second probability distribution 493 over possible non-synthetic speech recognition hypotheses includes one of possible phoneme labels or possible word piece labels. Thereafter, the supervised loss module 440 may determine a non-synthetic speech loss term 443 based on the second probability distribution 493 over possible non-synthetic speech recognition hypotheses and the corresponding ground-truth 420. The second fine-tuning stage fines-tune the ASR model 200 on the non-synthetic speech loss term 443 using the DP-PEFT technique by updating only a subset of newly added or existing parameters of the pre-trained audio encoder 210.

In the example shown, the pre-trained audio encoder 210 integrates a PEFT module 480 which may include adapters 480a that each add two low-rank projection matrices and one activation layer before layer normalization and after a feed-forward layer in each corresponding multi-head attention layer (e.g., Conformer layer) of the pre-trained audio encoder 210, a Low-Rank Adaptation (LoRa) 480b that adds two low-rank projection matrices parallel to feed-forward layers of each corresponding multi-head attention layer (e.g., Conformer layer) of the pre-trained audio encoder 210, random projection 480c which modifies LoRa by freezing the downside projection matrix and only updating parameters of the upscale projection matrix in order to reduce the number of trainable parameters, and Bias-Term Fine-Tuning (BitFit) 480d where only bias parameters of the stack of multi-head attention layers of the pre-trained audio encoder 210 are updated during the fine-tuning. Thus, when the pre-trained audio encoder 210 integrates the adapters 480a, the second fine-tuning stage 400b updates only parameters of the adapters based on the nonsynthetic speech loss terms 443. When the pre-trained audio encoder 210 integrates LoRA 480b, the second fine-tuning stage 400b updates only parameters of the two low-rank projection matrices based on the non-synthetic speech loss terms 443. When the pre-trained audio encoder 210 integrates random projection 480c, the second fine-tuning stage 400c updates only parameters of the upscale projection matrices based on the non-synthetic speech loss terms 443 while freezing the downside projection matrices. When the pre-trained audio encoder 210 integrates BitFit 480d, the second fine-tuning stage 400d updates only the bias parameters of the stack of multi-head attention layers (e.g., Conformer layers) based on the non-synthetic speech loss terms 443. Notably, the DP-DEFT technique implementing one of the PEFT modules 480 permits the second fine-tuning stage 400b to fine-tune the ASR model 200 on the plurality of private training samples 402 according to the differential privacy budget defining the maximum acceptable amount of information about individual training samples of the plurality of private training samples that may be revealed or leaked by the ASR model 200 during inference.

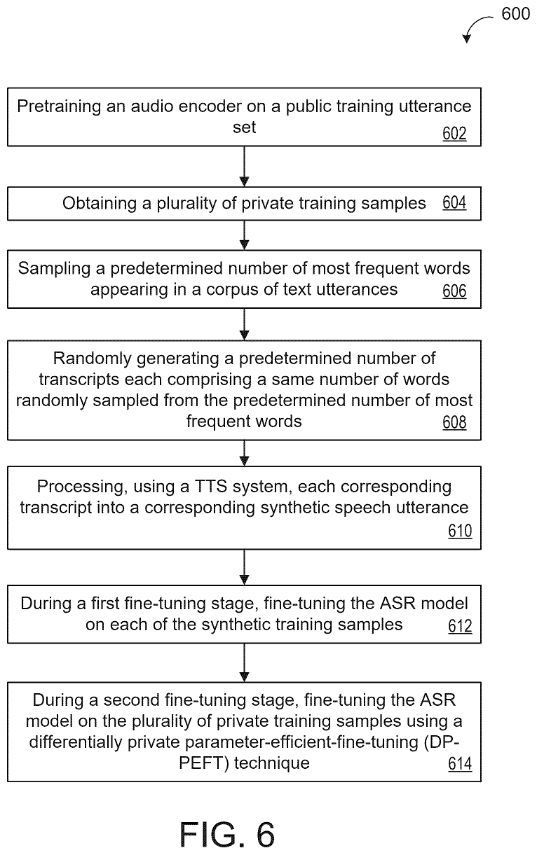

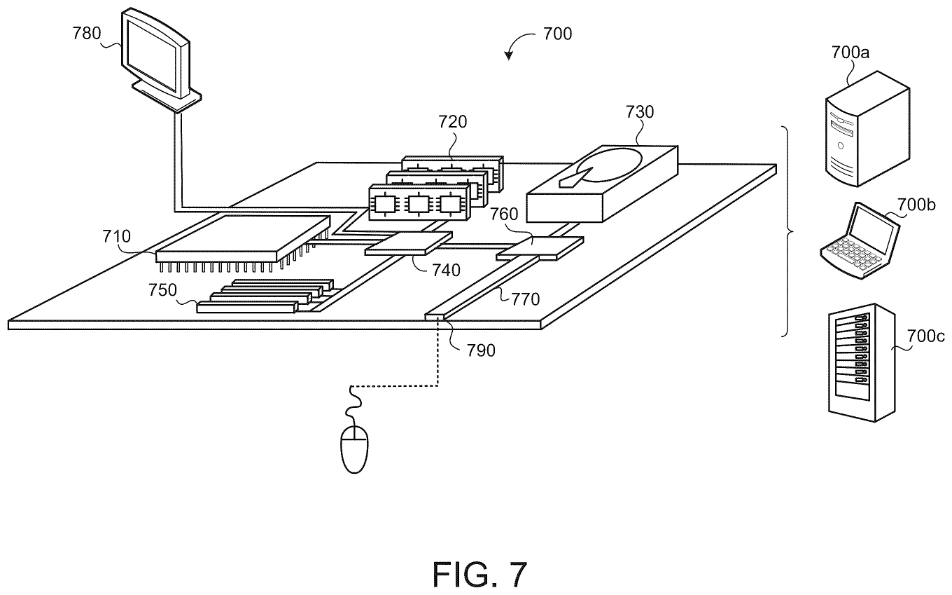

FIG. 6 is a flowchart of an example arrangement of operations for a computer-implemented method 600 of applying differentially private parameter-efficient fine-tuning (DP-PEFT) techniques for fine-tuning a large ASR model on downstream speech recognition tasks with a strict DP guarantee. The method 600 may execute on data processing hardware 710 (FIG. 7) using instructions stored on memory hardware 720 (FIG. 7). The data processing hardware 710 and the memory hardware 720 may reside on the remote computer/server 201 and/or the user device 102 of FIG. 1 each corresponding to a computing device 700 (FIG. 7).

At operation 602, the method 600 includes pre-training an audio encoder 210 on a public training utterance set including publicly-available utterances that include a plurality of un-transcribed non-synthetic speech utterances 306. Here, each un-transcribed non-synthetic speech utterance is not paired with a corresponding transcription. At operation 604, the method 700 includes obtaining a plurality of private training samples 402 that each include a corresponding non-synthetic speech utterance 432 paired with a corresponding transcription 420.

Operations 606-610 may be performed by the synthetic training sample generation process 500 of FIG. 5. From a corpus of text utterances 501, the method 600 also includes, at operation 606, sampling a predetermined number of most frequent words 503 that appear in the corpus of text utterances 501. At operation 608, the method 600 also includes randomly generating a predetermined number of transcripts 520. Each transcript 520 includes a same number of words randomly sampled from the predetermined number of most frequent words 503. At operation 610, for each corresponding transcript 520 of the predetermined number of transcripts 520, the method 600 also includes processing, using a text-to-speech (TTS) system 550, the corresponding transcript into a corresponding synthetic speech utterance 532. Here, the corresponding transcript 520 and the corresponding synthetic speech utterance 532 form a corresponding synthetic training sample 502.

At operation 612, the method 600 includes fine-tuning the ASR model on each of the synthetic training samples 502 during a first fine-tuning stage to each the ASR model to learn how to predict the transcripts 520 from the corresponding synthetic speech utterances 532. Here, the ASR model 200 includes the pre-trained audio encoder 210 and a decoder 390.

At operation 614, the method 600 includes fine-tuning the ASR model on the plurality of private training samples 402 using a differentially private parameter-efficient-finetuning (DP-PEFT) technique. Here, the DP-PEFT technique updates only a subset of newly added or existing parameters of the pre-trained audio encoder 210.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a public training utterance set;
pre-training an audio encoder on the public training utterance set;
obtaining a plurality of private training samples, each private training sample comprising a corresponding non-synthetic speech utterance paired with a corresponding transcription;
from a corpus of text utterances, sampling a predetermined number of most frequent words that appear in the corpus of text utterances,
randomly generating a predetermined number of transcripts, each transcript comprising a same number of words randomly sampled from the predetermined number of most frequent words;
for each corresponding transcript of the predetermined number of transcripts, processing, using a text-to-speech (TTS) system, the corresponding transcript to generate a corresponding synthetic speech utterance, wherein the corresponding transcript and the corresponding synthetic speech utterance form a corresponding synthetic training sample;
during a first fine-tuning stage for fine-tuning an automatic speech recognition (ASR) model comprising the pre-trained audio encoder and a decoder, fine-tuning the ASR model on each of the synthetic training samples to teach the ASR model to learn how to predict the transcripts from the corresponding synthetic speech utterances, and
during a second fine-tuning stage for fine-tuning the ASR model, fine-tuning, using a differentially private parameter-efficient-fine-tuning (DP-PEFT) technique, the ASR model on the plurality of private training samples, wherein the DP-PEFT technique updates only a subset of newly added or existing parameters of the pre-trained audio encoder.

2. The computer-implemented method of claim 1, wherein the public training utterance set includes publicly-available utterances comprising a plurality of un-transcribed non-synthetic speech utterances, each un-transcribed non-synthetic speech utterance not paired with a corresponding transcription.

3. The computer-implemented method of claim 2, wherein pre-training the audio encoder on the public training utterance set comprises:
for each corresponding un-transcribed non-synthetic speech utterance in the public training utterance set:
generating, at each of a plurality of output steps, using a random-projection quantizer, a target quantized vector token and a target token index for a corresponding audio feature in a sequence of audio features associated with the corresponding un-transcribed non-synthetic speech utterance, wherein the target token index maps the corresponding audio feature to the target quantized vector token stored in one or more codebooks;
after masking a subset of the audio features in the sequence of audio features associated with the corresponding un-transcribed non-synthetic speech utterance, generating, by the audio encoder, contrastive context vectors from corresponding masked audio features; and
deriving a contrastive loss term between the contrastive context vectors at the masked positions and the target token index; and
pre-training the audio encoder based on the contrastive loss terms derived for each of the un-transcribed non-synthetic speech utterances in the public training utterance set.

4. The computer-implemented method of claim 1, wherein the audio encoder comprises a stack of multi-head attention layers each including a multi-headed self-attention mechanism.

5. The computer-implemented method of claim 4, wherein the stack of multi-head attention layers comprises a stack of conformer layers.

6. The computer-implemented method of claim 5, wherein the stack of conformer layers comprises a stack of 24 layers having about 600 million parameters.

7. The computer-implemented method of claim 4, wherein the DP-PEFT technique comprises modifying the audio encoder to incorporate adapters that each incorporate two low-rank projection matrices and one activation layer, wherein only the parameters of the adapters are updated during the fine-tuning.

8. The computer-implemented method of claim 4, wherein the DP-PEFT technique comprises modifying the audio encoder to incorporate two low-rank projection matrices parallel to feed-forward layers of the audio encoder, wherein only parameters of the two low-rank projection matrices are updated during the fine-tuning.

9. The computer-implemented method of claim 4, wherein the DP-PEFT technique comprises Bias-Term Fine-Tuning (BitFit), wherein only bias parameters of the stack of multi-head attention layers are updated during the fine-tuning.

10. The computer-implemented method of claim 1, wherein fine-tuning, using the DP-PEFT technique, the ASR model on the plurality of private training samples fine-tunes the ASR model according to a differential privacy budget that defines a maximum acceptable amount of information about individual training samples of the plurality of private training samples that may be revealed or leaked by the ASR model.

11. A system comprising:
data processing hardware; and
memory hardware in communication with the data processing hardware and storing instructions that when executed on the data processing hardware cause the data processing hardware to perform operations comprising:
obtaining a public training utterance set;
pre-training an audio encoder on the public training utterance set;
obtaining a plurality of private training samples, each private training sample comprising a corresponding non-synthetic speech utterance paired with a corresponding transcription;
from a corpus of text utterances, sampling a predetermined number of most frequent words that appear in the corpus of text utterances;
randomly generating a predetermined number of transcripts, each transcript comprising a same number of words randomly sampled from the predetermined number of most frequent words,
for each corresponding transcript of the predetermined number of transcripts, processing, using a text-to-speech (TTS) system, the corresponding transcript to generate a corresponding synthetic speech utterance, wherein the corresponding transcript and the corresponding synthetic speech utterance form a corresponding synthetic training sample;
during a first fine-tuning stage for fine-tuning an automatic speech recognition (ASR) model comprising the pre-trained audio encoder and a decoder, fine-tuning the ASR model on each of the synthetic training samples to teach the ASR model to learn how to predict the transcripts from the corresponding synthetic speech utterances; and
during a second fine-tuning stage for fine-tuning the ASR model, fine-tuning, using a differentially private parameter-efficient-fine-tuning (DP-PEFT) technique, the ASR model on the plurality of private training samples, wherein the DP-PEFT technique updates only a subset of newly added or existing parameters of the pre-trained audio encoder.

12. The system of claim 11, wherein the public training utterance set includes publicly-available utterances comprising a plurality of un-transcribed non-synthetic speech utterances, each un-transcribed non-synthetic speech utterance not paired with a corresponding transcription.

13. The system of claim 12, wherein pre-training the audio encoder on the public training utterance set comprises:
for each corresponding un-transcribed non-synthetic speech utterance in the public training utterance set:
generating, at each of a plurality of output steps, using a random-projection quantizer, a target quantized vector token and a target token index for a corresponding audio feature in a sequence of audio features associated with the corresponding un-transcribed non-synthetic speech utterance, wherein the target token index maps the corresponding audio feature to the target quantized vector token stored in one or more codebooks;
after masking a subset of the audio features in the sequence of audio features associated with the corresponding un-transcribed non-synthetic speech utterance, generating, by the audio encoder, contrastive context vectors from corresponding masked audio features; and
deriving a contrastive loss term between the contrastive context vectors at the masked positions and the target token index; and
pre-training the audio encoder based on the contrastive loss terms derived for each of the un-transcribed non-synthetic speech utterances in the public training utterance set.

14. The system of claim 11, wherein the audio encoder comprises a stack of multi-head attention layers each including a multi-headed self-attention mechanism.

15. The system of claim 14, wherein the stack of multi-head attention layers comprises a stack of conformer layers.

16. The system of claim 15, wherein the stack of conformer layers comprises a stack of 24 layers having about 600 million parameters.

17. The system of claim 14, wherein the DP-PEFT technique comprises modifying the audio encoder to incorporate adapters that each incorporate two low-rank projection matrices and one activation layer, wherein only the parameters of the adapters are updated during the fine-tuning.

18. The system of claim 14, wherein the DP-PEFT technique comprises modifying the audio encoder to incorporate two low-rank projection matrices parallel to feed-forward layers of the audio encoder, wherein only parameters of the two low-rank projection matrices are updated during the fine-tuning.

19. The system of claim 14, wherein the DP-PEFT technique comprises Bias-Term Fine-Tuning (BitFit), wherein only bias parameters of the stack of multi-head attention layers are updated during the fine-tuning.

20. The system of claim 11, wherein fine-tuning, using the DP-PEFT technique, the ASR model on the plurality of private training samples fine-tunes the ASR model according to a differential privacy budget that defines a maximum acceptable amount of information about individual training samples of the plurality of private training samples that may be revealed or leaked by the ASR model.
